(19) United States
(12) Patent Application Publication
(10) Pub. No.: US 2004/0189790 A1
(43) Pub. Date: Sep. 30, 2004

(54) Laser array imaging lens and an image-forming device using the same

(76) Inventor: Hiromitsu Yamakawa, Saitama City (JP)

Correspondence Address: Arnold International, P.O. BOX 129, Great Falls, VA, 22066, US

(21) Appl. No.: 10/811,816

(22) Filed: Mar. 30, 2004

(30) Foreign Application Priority Data
Mar. 31, 2003 (JP) 2003-094199

(51) Int. Cl. B41J 2/45; B41J 15/14; B41J 27/00; G02B 13/08

(52) U.S. Cl. 347/244; 359/668

(57) ABSTRACT

A laser array imaging lens formed of a single lens component with or without a stop on the image side of the single lens component is disclosed. At least one surface of the single lens component is an anamorphic, aspheric surface. A diffractive optical element that is defined by a phase function may be provided, either superimposed on the anamorphic, aspheric surface or formed on another surface of the single lens component. Preferably, the following condition is satisfied:

0.5<L/(D₂·(1−1/M))<2.0

where

L is the on-axis distance from the laser array light source to the light-source-side of the laser array imaging lens;

D₂ is the on axis distance from the image-side surface of the laser array imaging lens to the position where the centers of the beams from the laser elements of the laser array light source intersect one another; and

M is the image magnification.

### BACKGROUND OF THE INVENTION

A well-known rotary polygon mirror has been generally used as the light scanning means in image-forming devices such as laser printers. Although a rotary polygon mirror provides superior scanning in terms of both higher speed and better accuracy in capturing or reproducing the correct shading as compared to when a galvanometer mirror is used for scanning, the subtle bending of scanning lines, the variation of scanning line pitch, as well as the variation of scanning line length that result from manufacturing variations deteriorate the quality of scanning when a rotary polygon mirror is used. Moreover, in a scanning unit that uses such a rotary polygon mirror, a sensor for detecting the timing of the scans is needed for making the starting points coincide. Furthermore, vibrations and/or noise may be generated due to the rotational operation of a rotary polygon mirror.

Various problems as described above arise when a rotary polygon mirror is used to scan a light beam. Moreover, there is a limitation as to both the scanning speed and acceleration of a rotary polygon mirror. Imaging techniques that are equivalent in result to scanning a laser light without using a rotary mirror have been investigated to further enhance the image-forming speed. When such techniques are used, beams from laser light sources need to be accurately guided onto a surface, and thus the development of an laser array imaging lens suited to this task is required.

Image-forming devices that use a so-called semiconductor laser array made by arraying multiple light emitting elements in rows as a light source and that use a laser array imaging lens that images light beams from such a light source onto a surface to be scanned are described Japanese Laid-Open Patent Applications H10-16297 and 2000-249915.

However, the laser array imaging lens described in Japanese Laid-Open Patent Application H10-16297 has a seven lens element construction that uses only spherical lenses. A laser array imaging lens of a lighter and simpler construction than this conventional example has been desired. Further, the laser array imaging lens described in Japanese Laid-Open Patent Application 2000-249915 is constructed of two anamorphic, aspheric lens elements and a stop. The two anamorphic, aspheric lens elements function to refract light rays that are situated at the center of the light beams that are incident onto the laser array imaging lens parallel to the optical axis so that they intersect in a region positioned on the optical axis of the laser array imaging lens, and a stop is placed at this position on the optical axis to thereby make the laser array imaging lens telecentric on the light-source side.

### BRIEF SUMMARY OF THE INVENTION

The present invention relates to an image-forming device, such as a laser printer, in which the light source is a semiconductor laser array made by arraying multiple light emitting elements in rows. Light is guided onto a surface to be scanned from the semiconductor laser array so as to form reproduced images on the surface to be scanned. In addition, the present invention relates to a laser array imaging lens that may be used in such an image-forming device. More particularly, the present invention provides a laser array imaging lens of simple construction that may be used to scan laser light from a semiconductor laser array light source onto a surface to be scanned without using a rotary polygon mirror, and an image-forming device such as a laser printer using the same.

### BRIEF DESCRIPTION OF THE DRAWINGS

The present invention will become more fully understood from the detailed description given below and the accompanying drawings, which are given by way of illustration only and thus are not limitative of the present invention, wherein:

FIGS. 1A and 1B are top and side views, respectively, of a laser printer according to Embodiment 1;

FIG. 2 shows a beam that has been emitted from a laser element such as an LED (light emitting diode);

FIG. 3 is a side view of a laser printer according to Embodiment 2;

FIG. 4 illustrates a semiconductor laser array light source formed of multiple laser elements and arranged in rows;

FIG. 5 illustrates a laser array imaging lens of the present invention that may be used in the laser printer of the present invention;

FIGS. 6A-6E show various aberration curves of the laser array imaging lens for use in the laser printer according to Embodiment 1; and

FIGS. 7A-7E show various aberration curves of the laser array imaging lens for use in the laser printer according to Embodiment 2.

### DETAILED DESCRIPTION

Definitions of the terms “lens element” and “lens component” that relate to this detailed description will now be given. The term “lens element” is herein defined as a single transparent mass of refractive material having two opposed refracting surfaces, which surfaces are positioned at least generally transverse to the optical axis of the laser array imaging lens. The term “lens component” is herein defined as (a) a single lens element spaced so far from any adjacent lens element that the spacing cannot be neglected in computing the optical image forming properties of the lens elements or (b) two or more lens elements that have their adjacent lens surfaces either in full overall contact or so close together that the spacings between adjacent lens surfaces of the different lens elements are so small that the spacings can be neglected in computing the optical image forming properties of the two or more lens elements. Thus, some lens elements may also be lens components. Therefore, the terms “lens element” and “lens component” should not be taken as mutually exclusive terms. In fact, the terms may frequently be used to describe a single lens element in accordance with part (a) above of the definition of a “lens component.” In accordance with the definitions of “lens component,” and “lens element” above, lens elements may also be lens components. Thus, the present invention may variously be described in terms of lens elements or in terms of lens components.

A laser array imaging lens of the present invention is provided in which beams of a semiconductor laser array light source formed by arraying multiple light emitting elements in rows are imaged onto an image surface so as to form a row of dots. The laser array imaging lens of the present invention is characterized by being anamorphic and causing light rays that emerge close to the center of the beams emitted from the light emitting elements to be refracted by the laser array imaging lens so as to intersect one another at a common point on the optical axis of the laser array imaging lens, and the laser array imaging lens consists of a single lens element having an aspherical surface on at least one surface.

It is preferable that the laser array imaging lens of the present invention includes one or more of the following: (a) an anamorphic, aspheric surface on at least one surface; (b) a stop that is arranged in the vicinity of a region where rays that are close to the center of the beams from the light emitting elements intersect each other; and (c) when combined with a laser array light source, that a specified condition is satisfied. The specified condition, to be discussed later in detail, specifies the acceptable range of a ratio that relates the on-axis distance from the laser array light source to the laser array imaging lens, the on-axis distance from the image-side surface of the laser array imaging lens to the position that rays refracted by the laser array imaging lens intersect the optical axis, and the image magnification.

The image-forming device of the present invention is characterized by including the laser array imaging lens of the present invention. In addition, the image-forming device of the present invention includes: a laser array light source made by arraying multiple light emitting elements in rows; means for independently modulating the individual light emitting elements of the semiconductor laser array light source based on a prescribed signal; and means for relatively moving a surface to be scanned that is arranged substantially at the image surface of the laser array imaging lens in the sub-scanning direction.

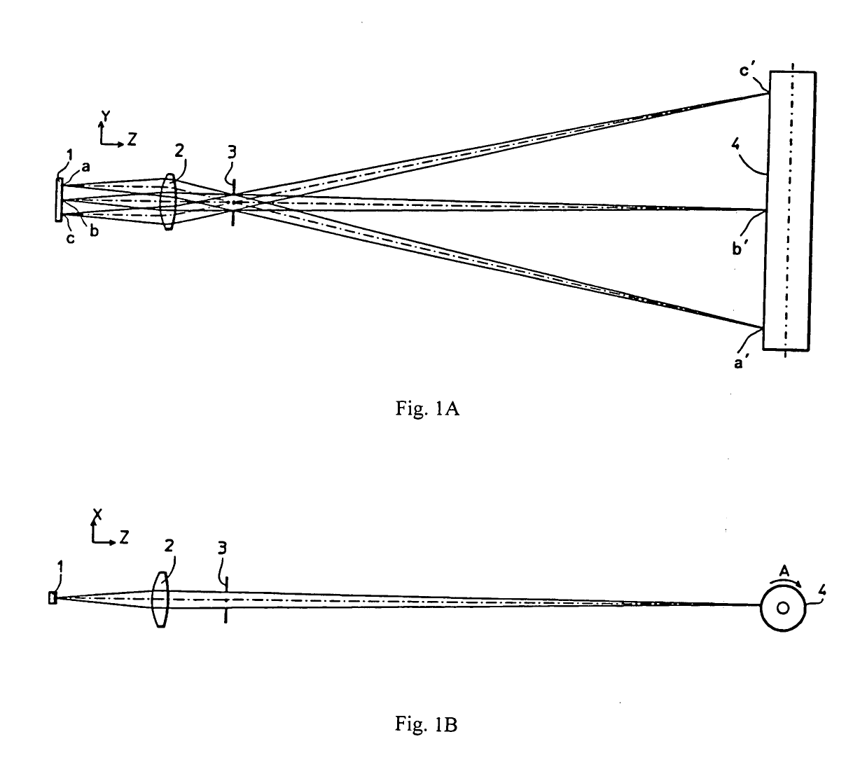

The invention will now be described in general terms with reference to FIGS. 1A and 1B, which show a top cross-sectional view and a side cross-sectional view, respectively, of a laser printer that uses the laser array imaging lens of the present invention. This laser printer device is provided with: a semiconductor laser array light source 1 that includes numerous light emitting elements arranged in a line that defines a first direction, herein called the scanning direction; and a laser array imaging lens 2 that converges the light from each light emitting element so that light rays from all the light emitting elements overlap in space, or in space as well as time, in a region centered about the optical axis of the laser array imaging lens 2 and so that each light emitting element is focused onto an image surface 4 in a non-overlapping manner. Positioned at the image surface is a document to be scanned so as to impart image information onto the document, which is moved in the sub-scanning direction after each exposure to all the individually modulated light beams in a row. Preferably all the individual light emitting elements emit light simultaneously, so as to obtain the equivalent of high-speed scanning in the scanning direction.

The above semiconductor laser array light source 1 is made by arraying over 2,000 very small semiconductor laser elements (called laser elements hereinafter) in one or more straight lines as light emitting elements. The individual laser elements can be modulated independently based on a prescribed signal so together they produce a “scan line” in the traditional sense. Although the term “scan line” is used herein, it should be noted that the present invention enables an entire line of light emitting elements, or even multiple lines of light emitting elements, to be imaged simultaneously onto an image surface so as to record one or more “scan lines”.

A light source having over 2,000 laser elements is needed to illuminate a scan line with a length sufficient to scan A6 size paper at a pitch of 600 dots per inch. Actually, since the short side of A6 paper (postcard size paper) has a length of 105 mm, if the A6 paper is oriented with its short side in the main scanning direction, the number of laser elements that should be arrayed is (600 dots per inch) times (105 mm/(25.4 mm per inch))=2,480 dots. However, printing is usually not needed for a range of several mm in each margin of the short side. Therefore, if over 2,000 laser elements are arrayed in a straight line, the printing of a scanning line at a pitch of 600 dots per inch onto A6 paper can be accomplished.

Thus, when light beams from the numerous laser elements that are arrayed in a straight line are imaged at prescribed positions in a straight line on an image surface 4 by the laser array imaging lens 2, a linear array of light spots (i.e., dots) that is equivalent to one scanning line can be formed by a one-time simultaneous light emission of the laser elements in the light source. Further, linear arrays of light dots equivalent to numerous scanning lines can be formed onto an image surface 4 at which a photosensitive material is positioned to thereby form a reproduced image by performing light emission from the light source 1 at a prescribed timing while secondarily moving the photosensitive material at a prescribed speed in the sub-scanning direction (the direction of the arrow A in FIG. 1B, which is roughly perpendicular to the direction of the dot arrays).

The present invention eliminates problems that arise when using a rotary polygon mirror as a light scanning means because no rotary polygon mirror is needed according to the present invention, since the light beams from respective laser elements are modulated independently and are output to form a dot array line that is equivalent to a single scanning line. Namely, various problems that accompany the skewing of the mirror surfaces, such as variation in the scanning line pitch, do not arise because light scanning is not carried out by a mechanical light scanning means such as a rotary polygon mirror. Further, a sensor as is necessary in the case of using a rotary polygon mirror to obtain the timing of the start of the scanning lines is unnecessary. In addition, vibration and noise that accompany scanning in the traditional sense, are all but eliminated, and a long service life of the image scanning device can be anticipated because there are no high-speed moving parts, as when using a rotary polygon mirror. In addition, higher printing speeds can be achieved because the laser elements arrayed in a straight line can simultaneously emit light so as to print an entire line, or even multiple lines, onto a surface to be scanned simultaneously.

Semiconductor laser elements are preferred for use as the light emitting elements of the light source 1 because of the speed at which they may be turned on and off, or otherwise controlled so as to modulate the intensity of light produced, as well as the maximum intensity that these light emitting elements can produce. As other light emitting means, a total internal reflection system may be used, for example, wherein numerous divided beams of light from a gas laser such as a He—Ne laser are simultaneously modulated by a prescribed modulator. Although such systems have in the past been considered, the optical system tends to be extremely complicated for this arrangement, and a high-output laser tube is needed to insure a sufficient light intensity for each divided beam, since the laser tube output is typically divided into several thousand beams. Thus, in such a light scanning system, the size of the gas laser tube tends to be large, and a large distance from the laser tube to the light modulator is required. Hence, when using such a system, making the device compact becomes difficult and the cost is relatively high.

The laser array imaging lens 2 focuses light in such a way that rays close to the center of each light beam emitted from the laser elements of the light source 1 intersect within a common region and such that the conjugate points to the light emitting elements that form the light source 1 are arranged as one or more lines of dots at the image surface. Further, the stop may be positioned on the optical axis of the laser array imaging lens such that its center substantially coincides with the center of the common region. For example, light beams output from laser elements of the light source 1 at points a, b and c are conjugated to the points a′, b+, and c′, respectively, on the image surface 4. Typically, a photosensitive material will be positioned at the image surface 4 so as to capture the image data reproduced there. It should be noted that a row of points of the laser elements of the light source 1 and a row of points on the image surface 4 corresponding to these points have a left-right reverse relationship. The region of intersection of these rays is preferably on the optical axis of the laser array imaging lens 2.

The laser array imaging lens 2 includes at least one aspherical surface, the shape of which is at least partially defined using Equation (A) below.

Z=ρ²/R/((1+(1−K·ρ²/R²)^{1/2})+ΣA₂ᵢβ²ⁱ Equation (A)

where

Z is the length (in mm) of a line drawn from a point on the aspheric lens surface at a distance ρ from the optical axis to the tangential plane of the aspheric surface vertex,

R is the radius of curvature of the aspheric lens surface on the optical axis,

ρ is the distance (in mm) from the optical axis,

K is the eccentricity, and

Aᵢ is the ith aspheric coefficient and the summation extends over i.

In embodiments of the invention disclosed below, only the aspheric coefficients A₄, A₆, A₈ and A₁₀ are non-zero.

The laser array imaging lens of the present invention consists of a single lens element, with or without a stop at the common region, mentioned above. By making the laser array imaging lens 2 of a single lens element construction, assembly cost is reduced because high assembly accuracy is not required. Also, the laser array imaging lens tends to be more compact and lighter in weight than it would be otherwise.

It is preferable that at least one surface of the laser array imaging lens 2 be aspheric and also have an anamorphic shape, meaning that its refractive power in the scanning direction and in the sub-scanning direction are not the same. The shape of the anamorphic, aspheric surface of the laser array imaging lens 2 is defined using Equation (B) below:

Z′=(CR·X²+Y²/R′)/{1+(1-[(K_{AX}·(CR·X)²+K_{AY}·(Y/R′)²])^{1/2}}+ΣA₂ᵢ·[(1−Kᵢ)·X²+(1+Kᵢ)·Y²]ⁱ Equation (B)

where

Z′ is the length (in mm) of a line drawn from a point situated at position (X,Y) on the aspheric lens surface to the tangential plane at the aspheric lens surface vertex;

X is the X direction component of the distance of the point from the optical axis;

Y is the Y direction component of the distance of the point from the optical axis;

CR is the paraxial curvature in a plane containing the X and Z axes;

R′ is the paraxial radius of curvature in a plane containing the Y and Z axes;

K_{AX} is the eccentricity of the X direction;

K_{AY} is the eccentricity of the Y direction;

A₂ᵢ is a rotational symmetry component aspheric coefficient, where i=2−5; and,

Kᵢ is a non-rotational symmetry component aspheric coefficient, where i=2−5.

By one surface of the laser array imaging lens being an anamorphic surface, focusing can be separately performed in both the scanning and sub-scanning directions. Thus, when an astigmatic light beam is emitted from the laser elements (as is the norm), the different curvatures of field in the two directions can be easily corrected. Also, by making both surfaces of the laser array imaging lens 2 to be anamorphic surfaces, the beam spot shapes imaged onto the image surface 4 can be adjusted to desirable shapes by appropriately designing the image magnification in the scanning and sub-scanning directions to be different.

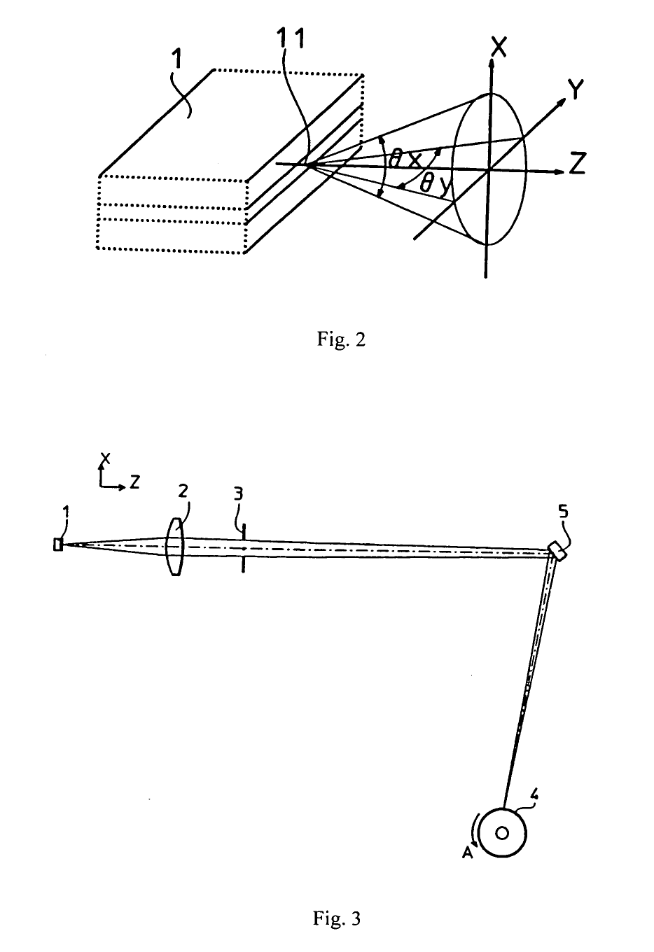

As mentioned above and as illustrated in FIG. 2, a semiconductor laser typically emits light having different beam widths θy in the Y direction versus θx in the X direction. Thus, referring to FIG. 2, if the shape of a laser array imaging lens 2 is made to be rotationally symmetric about the optical axis, the beam spot shapes on the image surface 4 will roughly coincide in shape to that of the beam shape of the emitted light from the semiconductor laser. By making both surfaces of the laser array imaging lens 2 to be anamorphic, the beam spot shapes that are imaged onto the image surface 4 can be adjusted in both directions independently so as to have any desirable shape.

It is preferable that the laser array imaging lens 2 has one surface with a diffractive optical element (DOE) superimposed thereon. The diffractive optical element has a phase function that is defined using a phase function Φ that is defined using Equation (C) below:

Φ=ΣCᵢ·Y²ⁱ Equation (C)

where

Y is the distance from the optical axis; and,

Cᵢ is the coefficient of Y²ⁱ.

In the embodiment disclosed below containing a DOE surface, the phase function coefficients Cᵢ are zero except for i=1.

The diffractive optical element functions to add an optical path difference of λ·Φ/(2π) to the diffracted light, with the wavelength of the incident light being denoted as λ. The diffractive optical element (DOE) may be combined in a superimposed manner with the anamorphic, aspheric surface or with the aspheric surface.

Irregularities of imaging caused by fluctuations generated due to a difference in the emitted center wavelength of different laser elements can be minimized by the use of a diffractive optical element having a phase function, as mentioned above. The positional deviation of the imaged beam spots on the image surface 4 caused by a fluctuation of wavelength can be prevented despite a fluctuation in wavelength of emitted light among different laser elements due to the manufacturing process as well as due to a fluctuation of emitted light due to changes in ambient temperature.

Although the laser array imaging lens 2 works in such a way that rays close to the center of the beams from the laser elements intersect in a common region, as described above, it is preferable that a stop 3 be arranged in the vicinity of the common region. It is desirable that the aperture dimensions of the stop 3 be made changeable independently in the arraying direction of the laser elements and in a direction perpendicular thereto so that the beam spot shapes imaged on the image surface 4 can be easily changed. The aperture shape of the stop 3, such as a circle, ellipse, rectangle, etc. and the dimensions thereof can be properly determined.

It is desirable that the laser array imaging lens 2 be made telecentric on the light-source side. Light beams emergent from a particular laser element do not have a uniform intensity, but instead the light intensity at the central part of each beam is the highest, with the light intensity decreasing as the field angle increases. Thus, where the laser elements are aligned in a plane perpendicular to the optical axis of the laser array imaging lens, the center rays of the light beams from the laser elements should be parallel and aligned with the optical axis. In order to accomplish this ideal and to insure that only rays near the center of each beam emitted by a light source reach the image surface, a stop is placed on-axis substantially at the back focal plane of the laser array imaging lens 2. In this manner, the laser array imaging lens 2 is made to be telecentric on the light-source side, and provides effective utilization of the light from the light source 1.

In terms of practical use, it is preferred that the angle between a ray (hereinafter called the principal ray) that passes through the center of the stop and the ray (hereinafter called the central ray) at the center of a light beam from a laser element in the light beams emergent from the laser elements in the space between the light source 1 and the laser array imaging lens 2 satisfy the following Conditions (1) and (2):

αy<θy/2 Condition (1)

αx<θx/2 Condition (2)

where

αy is the angle between the principal ray and the central ray as measured in the plane that contains the Y-Z axes, with the Y and Z axes oriented as illustrated in FIG. 2;

αx is the angle between the principal ray and the central ray as measured in the plane that contains the X-Z axes, with the X and Z axes oriented as illustrated in FIG. 2;

θy is the angle, as illustrated in FIG. 2, between the points at which the light intensity beam profile becomes 50% of the peak intensity at the center of the beam, as measured in the direction of the Y axis; and

θx is the angle, as illustrated in FIG. 2, between the points at which the light intensity beam profile becomes 50% of the peak intensity at the center of the beam, as measured in the direction of the X axis.

FIG. 2 shows a luminous flux emitted from a laser element 11, and the direction Y is the row direction of the laser elements. Furthermore, the typical ranges of the above-mentioned angels θy and θx are shown in FIG. 2. FIG. 2 shows rays emergent from a laser element, with the direction Y being the row direction of the laser array elements.

It is also preferable that the laser array imaging lens 2 satisfies the following Condition (3):

0.5<L/(D₂·(1−1/M) )<2.0 Condition (3)

where

L is the on-axis distance from the semiconductor laser array light source 1 to the light-source side of the laser array imaging lens 2;

D₂ is the on-axis distance from the image-side surface of the laser array imaging lens 2 to the position where the centers of the beams from the laser elements of the laser array light source intersect the optical axis; and

M is the image magnification.

The stop 3 is arranged substantially at the distance D₂ from the image-side surface of the laser array imaging lens. By satisfying the above Condition (3), the laser array imaging lens 2 can more favorably correct aberrations while being substantially telecentric on the light-source side. If the lower limit of Condition (3) is not satisfied, it becomes difficult to favorably correct various aberrations such as curvature of field and coma. If the upper limit of Condition (3) is not satisfied, it also becomes difficult to favorably correct various aberrations such as curvature of field and coma. In the embodiments shown below, a desirable design balance is achieved by also satisfying the following Condition (4):

0.8<L/(D₂·(1−1/M))<1.7 Condition (4)

where L, D₂ and M are as defined above. However, the upper and lower limits of Condition (4) are not strictly defined, as they may vary with design conditions, such as the amount of image magnification M.

It also is possible to use either optical glass or plastic as the lens material of the laser array imaging lens 2. Plastic is preferred since it is less costly to process or to mold, especially when the laser array imaging lens is made to have a long rectangular shape in the direction that the laser elements are arrayed so as to receive beams emergent from the semiconductor laser array light source 1 arrayed with the laser elements in rows.

A so-called “composite aspherical lens” component in which a thin plastic layer is provided at the surface of a spherical lens element that is made of a glass material can also be used as the aspherical lens in this invention.

The image-forming device of the present invention is not restricted to one of the above embodiments, and various changes of mode or addition of functions are possible. For example, a construction in which a mirror 5 is arranged in the optical path in order to fold the light so as to make the image-forming device fit within a particular dimensional restriction may also be adopted, as shown in FIG. 3.

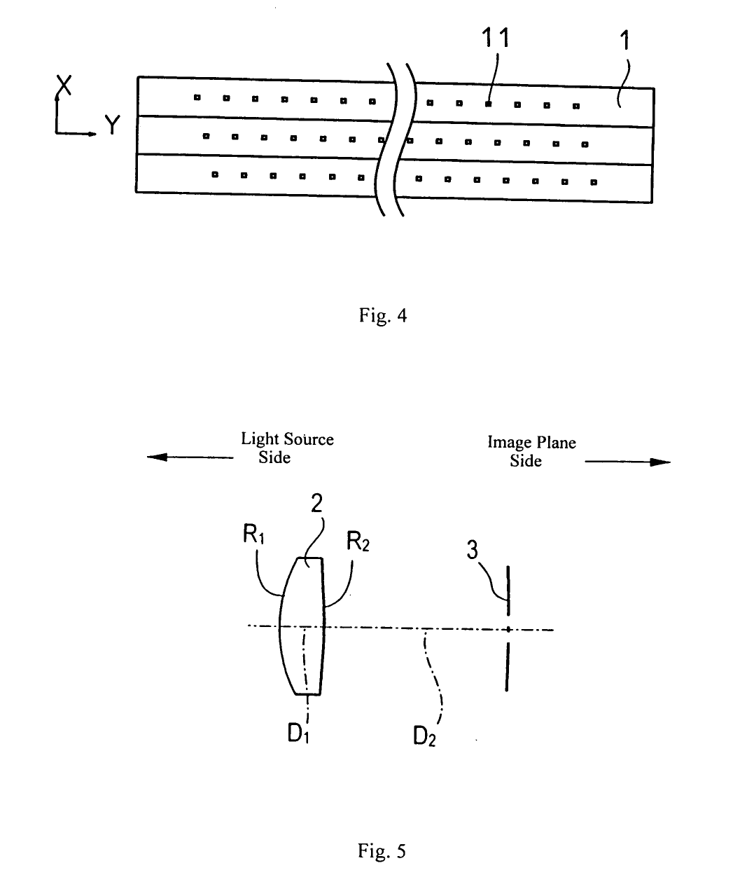

As shown in FIG. 4, the semiconductor laser array light source 1 made by arraying multiple laser elements in a row is not limited to there being a single row, as multiple laser element rows for high speed printing, high-density of dots, etc, may be used. For example, FIG. 4 is an example of a semiconductor laser array light source 1 having three laser element rows made by arraying multiple laser elements 11 in rows. The laser elements 11 of each row are shifted in the direction of the row an amount equal to ⅓ of the pitch of the laser element pitch in the Y direction. Preferably, the amount that the laser elements in different rows are shifted is equal to the distance between the laser elements in a given row divided by the number of rows in the array, so as to make uniform the distance between the laser elements in the semiconductor laser array light source 1 that is provided with multiple laser element rows.

It is also possible to arrange the surface of the laser elements of the semiconductor laser array light source 1 into a prescribed circular arc with a concave shape toward the laser array imaging lens 2 by facing the laser elements toward the laser array imaging lens 2. Thus, it is possible to effectively guide directional beams from the semiconductor laser array light source 1 to the pupil of the laser array imaging lens 2 without requiring a telecentric system such as discussed above. Even if the laser elements of the semiconductor laser array light source 1 are not arrayed into a circular arc of a concave shape as described above, the same effects are obtained if, as both ends of the semiconductor laser array are approached, the laser elements are increasingly angled inward so that the direction of the light emission of each is toward the optical axis of the laser array imaging lens 2.

Moreover, the number of laser elements of the semiconductor laser array light source 1 may be varied by selecting whatever number is appropriate for a particular intended purpose.

For example, if the illumination at the ends of the scanning line on the surface to be scanned is lower than at the center of the scanning line (i.e., on the optical axis), it is possible to achieve a greater uniformity of illumination of the scanned surface by adjusting the output intensity of the laser elements of the semiconductor laser array light source 1.

Furthermore, in the image-forming device of the present invention, a parallel-plate cover glass or a filter that is made of glass or plastic can be arranged between the semiconductor laser array light source 1 and the image surface 4 so as to protect the surface to be scanned and/or prevent dust from obscuring one or more pixels. Also, a very small lens can be arranged close to the light source to properly adjust the expansion angle of the beams in one direction, thereby compensating for the astigmatic difference of the light beams emitted from the laser elements.

Two specific embodiments of the laser array imaging lens according to the present invention will now be set forth in detail.

### EMBODIMENT 1

The construction of a laser array imaging lens according to Embodiment 1 of the present invention is shown in FIG. 5. This laser array imaging lens 2 is formed of, in order from the light-source side, a lens component having its surface on the light-source side be an anamorphic, aspheric surface having a different refractive power in the direction of the linear array(s) of the laser elements versus the refractive power in a direction that is perpendicular thereto, and the surface on the image side is made to be an aspherical surface. Rays close to the center of the beams from the laser elements intersect each other roughly at a point on the optical axis of the laser array imaging lens 2 due to being refracted by the laser array imaging lens 2, and a stop 3 is arranged in this position so as to make the laser array imaging lens 2 substantially telecentric on the light-source side.

Table 1 below lists the surface number # in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number V_{d} measured relative to the d-line of the optical material of each lens element of Embodiment 1. The middle portion of Table 1 lists the overall focal length f of the laser array imaging lens, the f-number F_{NO}, the on-axis distance L from the semiconductor laser array light source to the light-source side of the laser array imaging lens, the laser array imaging lens center thickness D₁, the on-axis distance L′ from the image-side surface of the laser array imaging lens to the image surface, the image magnification M, the total combined length TCL of the image forming device as measured from the laser array light source to the image surface, as well as the value of L/(D₂·(1−1/M)) corresponding to the above Condition (3). The lower portion of the table lists the coefficients CR, K_{AX}, K_{AY}, A₄, K₂, A₆, K₃, A₈, K₄, A₁₀, and K₅ of the anamorphic, aspheric surface #1 and the coefficients K, A₄, A₆, A₈, and A₁₀ of the aspheric surface #2 for the laser array imaging lens 2 relating to this embodiment. An “E” in the data indicates that the number following the “E” is the exponent to the base 10. For example, “1.0E-2” represents the number 1.0×10⁻².

TABLE 1

| # | R | D | N_{780 nm} | ν_{d} |
|---|---|---|---|---|
| 1* | 51.6470 | 14.0000 | 1.57166 | 30.3 |
| 2* | −123.7567 | 58.0000 | | |
| 3 | ∞ (stop) | | | |

| | |
|---|---|
| f = | 65.649 |
| F_{NO} = | 65.000 |
| L = | 70.702 |
| D₁ = | 14.000 |
| L′ = | 615.008 |
| M = | −8.467 |
| TCL = | 699.710 |
| L/(D₂ · (1 − 1/M)) = | 1.090 |

| | |
|---|---|
| Surface #1 | |
| (anamorphic, | Surface #2 |
| aspheric surface) | (aspheric surface) |

| | | | |
|---|---|---|---|
| CR = | 1.9375E−2 | K = | 2.5828E+1 |
| K_{AX} = | 6.1292E−1 | A₄ = | 7.6891E−6 |
| K_{AY} = | 1.3963 | A₆ = | −6.7185E−10 |
| A₄ = | 3.0349E−6 | A₈ = | −1.3883E−15 |
| K₂ = | 6.2849E−4 | A₁₀ = | 8.9038E−21 |
| A₆ = | 9.2680E−10 | | |
| K₃ = | −1.1775 | | |
| A₈ = | 2.5164E−14 | | |
| K₄ = | −1.1712 | | |
| A₁₀ = | −1.6262E−17 | | |
| K₅ = | 2.6345 | | |

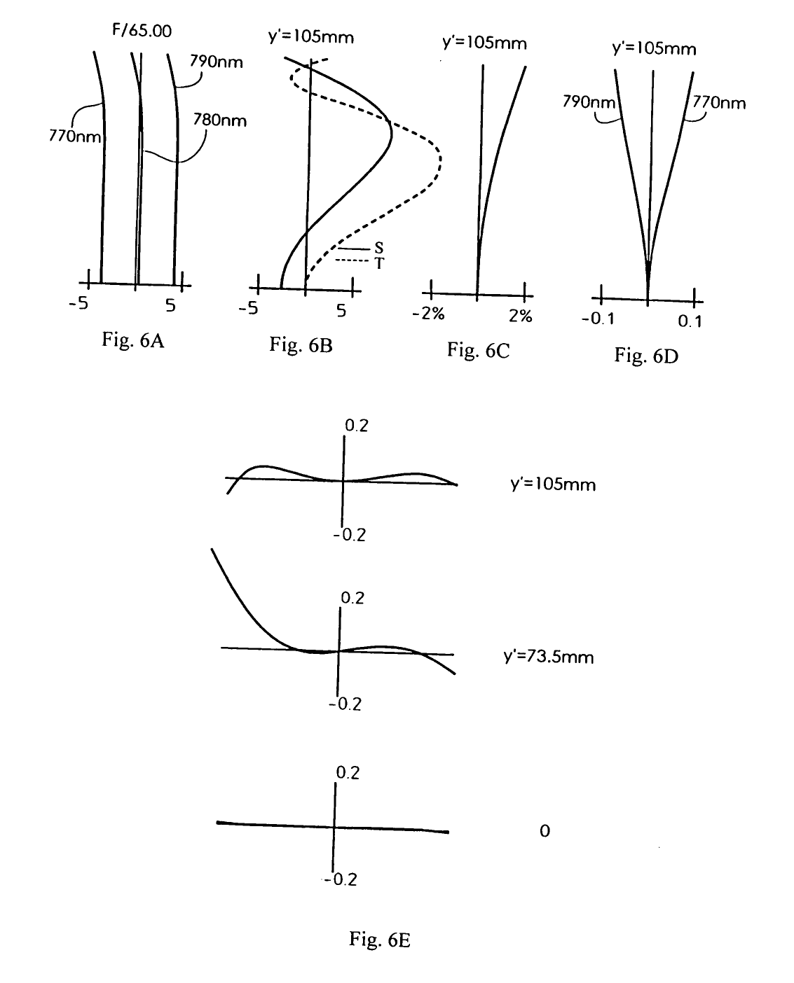

FIGS. 6A-6D show the spherical aberration, astigmatism, distortion and lateral color, respectively, for this embodiment. The spherical aberration (in mm) is shown for the wavelengths 770 nm, 780 nm and 790 nm, the astigmatism (in mm) is shown for both the sagittal S and tangential T image surface, and the lateral color (in mm) is shown for the wavelengths 770 nm and 790 nm. The f-number F_{NO} of this embodiment is listed in FIG. 6A and the maximum ray height y′=105 mm is listed in FIGS. 6B-6D. FIG. 6E shows the coma (in mm) for ray heights y′ of zero, 73.5 mm and 105 mm. As is evident from FIGS. 6A-6E, all these aberrations are favorably corrected for a wavelength of 780 nm.

### EMBODIMENT 2

The laser array imaging lens according to this embodiment is very similar in construction to that shown in FIG. 5 and, to the scale of FIG. 5, this embodiment does not differ in appearance from that shown in FIG. 5. However, a diffractive optical element DOE defined by a phase function is superimposed on the aspheric image-side surface of the laser array imaging lens 2. As in Embodiment 1, a stop 3 is also provided in order to make the laser array imaging lens 2 be substantially telecentric on the light-source side.

Table 2 below lists the surface number # in order from the light-source side, the radius of curvature R (in mm) near the optical axis of each optical surface, the on-axis spacing D (in mm) between surfaces, the index of refraction N₇₈₀ of the optical material of each lens element as measured at a wavelength of 780 nm, and the Abbe number vd measured relative to the d-line of the optical material of each lens element of Embodiment 2. The middle portion of Table 2 lists the overall focal length f of the laser array imaging lens, the f-number F_{NO}, the on-axis distance L from the semiconductor laser array light source to the light-source side of the laser array imaging lens, the laser array imaging lens center thickness D₁, the on-axis distance L′ from the image-side surface of the laser array imaging lens to the image surface, the image magnification M, the total combined length TCL of the image forming device as measured from the laser array light source to the image surface, as well as the value of L/(D₂(1-1/M )) corresponding to the above Condition (3). The lower portion of the table lists the coefficients CR, K_{AX}, K_{AY}, A₄, K₂, A₆, K₃, A₈, K₄, A₁₀, and K₅ of the anamorphic, aspheric surface #1 and the coefficients K, A₄, A₆, A₈, and A₁₀ of the aspherical surface as well as the coefficient C₁ of the phase function of the superimposed DOE surface #2 for the laser array imaging lens 2 relating to this embodiment. An “E” in the data indicates that the number following the “E” is the exponent to the base 10. For example, “1.0E-2” represents the number 1.0×10⁻².

TABLE 2

| # | R | D | N_{780 nm} | ν_{d} |
|---|---|---|---|---|
| 1* | 51.7022 | 14.0000 | 1.57166 | 30.3 |
| 2* | −141.9601 | 58.0000 | | |
| 3 | ∞ (stop) | | | |

| | |
|---|---|
| f = | 64.639 |
| F_{NO} = | 65.000 |
| L = | 69.455 |
| D₁ = | 14.000 |
| L′ = | 605.550 |
| M = | −8.467 |
| TCL = | 689.005 |
| L/(D₂ · (1 − 1/M)) = | 1.071 |

| | |
|---|---|
| Surface #1 | Surface #2 |
| (anamorphic, | (aspheric, |
| aspheric surface) | DOE surface) |

| | | | |
|---|---|---|---|
| CR = | 1.9375E−2 | K = | 2.5297E+1 |
| K_{AX} = | 1.2749 | A₄ = | 7.5142E−6 |
| K_{AY} = | 1.7126 | A₆ = | −6.5830E−10 |
| A₄ = | 3.0385E−6 | A₈ = | −1.3312E−15 |
| K₂ = | 2.5488E−2 | A₁₀ = | 1.1055E−20 |
| A₆ = | 9.2740E−10 | C₁ = | −3.5000 |
| K₃ = | −1.1637 | | |
| A₈ = | 2.5169E−14 | | |
| K₄ = | −1.1842 | | |
| A₁₀ = | −1.6135E−17 | | |
| K₅ = | 2.2299 | | |

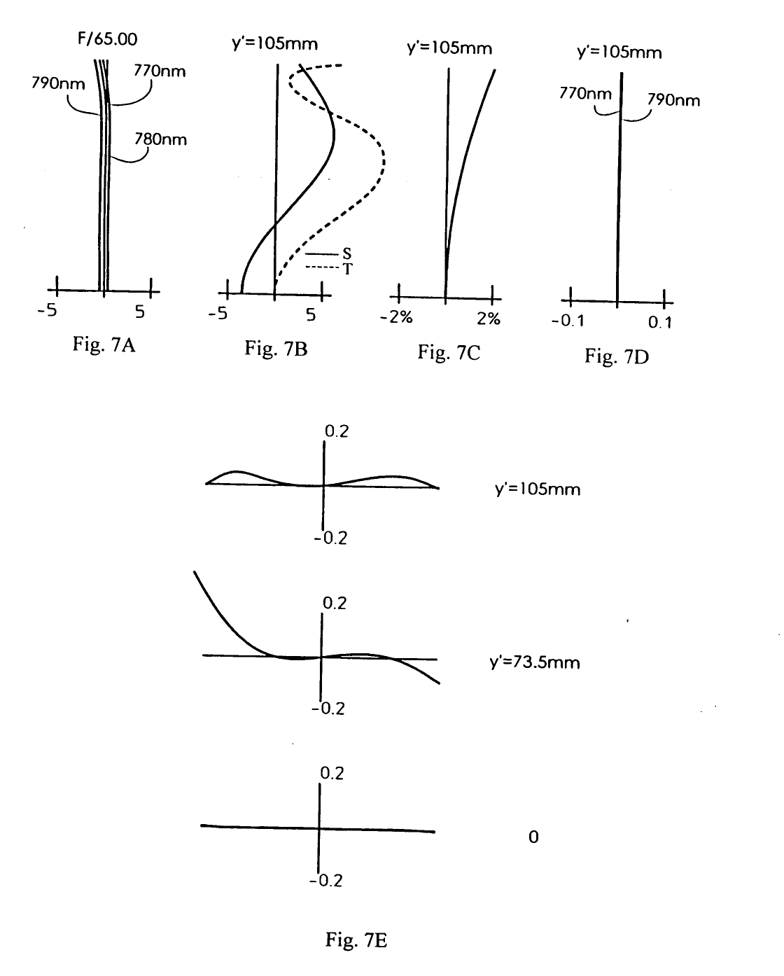

FIGS. 7A-7D show the spherical aberration, astigmatism, distortion and lateral color, respectively, for this embodiment. The spherical aberration (in mm) is shown for the wavelengths 770 nm, 780 nm and 790 nm, the astigmatism (in mm) is shown for both the sagittal S and tangential T image surface, and the lateral color (in mm) is shown for the wavelengths 770 nm and 790 nm. The F_{NO} of this embodiment is listed in FIG. 7A and the maximum ray height (y′=105 mm) is listed in FIGS. 7B-7D. FIG. 7E shows the coma (in mm) for ray heights y′ of zero, 73.5 mm and 105 mm. As is evident from FIGS. 7A-7E, all these aberrations are favorably corrected, with the spherical aberration and lateral color aberration being much improved for the wavelengths 770 nm and 790 nm by the action of the DOE surface having a phase function being superimposed on a rotationally symmetric, aspheric surface. This embodiment enables the maintaining of satisfactory imaging properties even if a fluctuation of wavelengths occurs among one or more of the semiconductor laser array elements.

The invention being thus described, it will be obvious that the same may be varied in many ways. For example, the specific construction values given in the tables above may be varied, the DOE surface can be superimposed on the anamorphic, aspheric surface and/or the order of the surfaces may be reversed. Furthermore, the laser array imaging lens of the present invention is not limited to use in a laser printer. For example, it can be used in an image-reading device in which image information is read by placing an object (e.g., a document of interest) on a surface to be scanned, illuminating the laser elements of a semiconductor laser array light source 1 by flashing them sequentially or simultaneously, moving the object image in a direction roughly perpendicular to the main scanning direction (i.e., in the sub-scanning direction), and providing a means for detecting light reflected from the object. In the above embodiments, the image surface and the surface to be scanned coincide. However, this is not required. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. A laser array imaging lens consisting of:
a single lens component with or without a stop positioned on the image side of the single lens component;
at least one surface of the single lens component is both anamorphic and aspheric; and
a diffractive optical element that is either superimposed on said at least one surface or is formed on another surface of the single lens component, said diffractive optical element being defined by a phase function.

2. The laser array imaging lens according to claim 1, wherein a stop is positioned on the image side of the single lens component at a specified distance.

3. In combination:
a laser array light source; and
a laser array imaging lens which receives light from the laser array light source, the laser array imaging lens consisting of a single lens component with or without a stop positioned on the image side of the single lens component, with at least one surface of the single lens component being both anamorphic and aspheric;
wherein the following condition is satisfied
0.5<L/(D₂·(1-1/M))<2.0
where
L is the distance from the laser array light source to the light-source side of the laser array imaging lens;
D₂ is the distance along the optical axis from the image-side surface of the laser array imaging lens to the position where the centers of the beams from the laser elements of the laser array light source intersect the optical axis after being refracted by the laser array imaging lens; and
M is the image magnification.

4. The combination according to claim 3, wherein a stop is positioned on the image side of the single lens component at a specified distance.

5. An image-forming device that includes the laser array imaging lens according to claim 1, and further comprises:
a laser array light source made by arraying multiple light emitting elements in one or more rows;
means for independently modulating the individual light emitting elements of the laser array light source, based on a prescribed signal; and
means for relatively moving a surface to be scanned, that is positioned substantially at an image surface of the laser array imaging lens, in a sub-scanning direction that is roughly perpendicular to the direction of the image dots that form one or more rows at the image surface.

6. An image-forming device that includes the laser array imaging lens according to claim 2, and further comprises:
a laser array light source made by arraying multiple light emitting elements in one or more rows;
means for independently modulating the individual light emitting elements of the laser array light source, based on a prescribed signal; and
means for relatively moving a surface to be scanned and that is positioned substantially at the image surface of the laser array imaging lens, in a sub-scanning direction that is roughly perpendicular to the direction of the imaged dots that form one or more rows at the image surface.

7. An image-forming device that includes the combination according to claim 3, and further comprises:
means for independently modulating the individual light emitting elements of the laser array light source, based on a prescribed signal; and
means for relatively moving a surface to be scanned and that is positioned substantially at the image surface of the laser array imaging lens, in a sub-scanning direction that is roughly perpendicular to the direction of the imaged dots that form one or more rows at the image surface.

8. An image-forming device that includes the combination according to claim 4, and further comprises:
means for independently modulating the individual light emitting elements of the laser array light source, based on a prescribed signal; and
means for relatively moving a surface to be scanned and that is positioned substantially at the image surface of the laser array imaging lens, in a sub-scanning direction that is roughly perpendicular to the direction of the imaged dots that form one or more rows at the image surface.

9. The laser array imaging lens according to claim 1, wherein the single lens component consists of a single lens element.

10. The laser array imaging lens according to claim 2, wherein the single lens component consists of a single lens element.

11. The combination according to claim 3, wherein the single lens component consists of a single lens element.

12. The combination according to claim 4, wherein the single lens component consists of a single lens element.

13. The image-forming device according to claim 5, wherein the single lens component consists of a single lens element.

14. The image-forming device according to claim 6, wherein the single lens component consists of a single lens element.

15. The image-forming device according to claim 7, wherein the single lens component consists of a single lens element.

16. The image-forming device according to claim 8, wherein the single lens component consists of a single lens element.

17. The laser array imaging lens according to claim 2, wherein the stop is positioned so that the laser array imaging lens is substantially telecentric on the light-source side.

18. The combination according to claim 4, wherein the stop is positioned so that the laser array imaging lens is substantially telecentric on the light-source side.

19. The image-forming device according to claim 6, wherein the stop is positioned so that the laser array imaging lens is substantially telecentric on the light-source side.

20. The image-forming device according to claim 8, wherein the stop is positioned so that the laser array imaging lens is substantially telecentric on the light-source side.
